(19) United States
(12) Patent Application Publication
(10) Pub. No.: US 2022/0375304 A1
(43) Pub. Date: Nov. 24, 2022

(54) GAMING SYSTEM AND METHOD

(71) Applicant: Inspired Gaming (UK) Limited, Staffordshire (GB)

(72) Inventor: Steven Collett, Burton on Trent (GB)

(21) Appl. No.: 17/296,668

(22) PCT Filed: Nov. 26, 2019
(86) PCT No.: PCT/GB2019/053325

§ 371 Date: May 25, 2021

(30) Foreign Application Priority Data
Nov. 26, 2018 (GB) 1819220.3

(51) Int. Cl. G07F 17/32; G06Q 50/34; A63F 5/00

(52) U.S. Cl. CPC G07F 17/3267; G07F 17/322; G07F 17/3288; G06Q 50/34; A63F 5/00

(57) ABSTRACT

A gaming system is described comprising a playing surface having a game wager placement area having markings thereon for identification and placement of wagers entered by a player, the game wager placement area defining a plurality of locations, each such location indicating one of a set of standard available wagers associated with an outcome of the game outcome generator; a game outcome area including a game outcome generator configured to determine and show one of a plurality of chance game outcomes; a plurality of tokens each having a nominal value, each such token being placeable onto a selected location on the game wager placement area, thereby to constitute placement one of the set of standard available wagers; whereby wagers may be placed according to a set of predefined wagering rules associated with the said plurality of locations; a feature entry outcome generator configured to determine, for each game event having a pre-determined wagered amount, a choice between at least a first outcome with a feature entry probability and a second outcome. The gaming system is set up such that in the event of the first outcome the game outcome generator is caused to determine and show one of the plurality of chance game outcomes and wagers placed by a player are settled based on the nominal value of each placed token in accordance with the set of predefined wagering rules; in the event of the second outcome the pre-determined wagered amount is lost; the feature entry probability is determined by a calculation that takes account of the ratio of the pre-determined wagered amount to the total nominal value of each placed token. A gaming method is also described. The game is for example roulette.

The invention is a gaming system and method that confers enhanced functionality in relation to casino table games, and in particular roulette. The invention in particular provides new wagering options for betting on a conventional table game such as roulette which are able to make use of standard bets and odds. The invention may be applicable to betting on a live table game and playing surface but is particularly applicable to betting on virtual or electronic representations of a table game such as a roulette game.

### INTRODUCTION

Casino table games such as baccarat, blackjack, craps and roulette are a popular means of entertainment. Traditionally, a casino table game might take the form of a physical table at a casino or like location including a table surface having wagering layout markings thereon for identification and placement of wagers entered by a plurality of players and including a game outcome apparatus to determine a chance game outcome, such as dice, playing cards, a roulette wheel etc.

Players place wagers on possible game outcomes on the wagering layout and a conventionally established of standard wagering options is normally provided for each established table game. For example, in a physical table game, players may place betting chips on the wagering layout on the table. The outcome is defined by the game outcome apparatus, and wagers are settled according to that outcome on the basis of established fixed odds for each of the standard wagering options.

The invention may find application for example in relation to roulette and the discussion below focuses on roulette in particular, but it will be understood that the same principles could be extended to other traditional casino table games that offer such a similar finite established set of fixed-odds standard wagering options.

Roulette is a well-established and widely played casino table game. The game outcome apparatus comprises a wheel divided into segments each of which has a coloured and numbered pocket for receiving a ball. The wheel traditionally includes 36 segments numbered 1 to 36, which are divided into two distinct colours, traditionally red and black, with one or two additional segments, numbered ‘0’ and ‘00’ also traditionally appearing on the wheel, and traditionally coloured green.

A game event comprises spinning the wheel and dropping the ball onto the wheel. and the game outcome is defined by the segment in which pocket the ball comes to rest.

Players place wagers on possible game outcomes on a wagering layout on which a variety of betting options are traditionally provided (for example including individual numbers, ranges and combinations, red/black, even/odd, etc.). The table includes a traditional wagering layout defining a plurality of locations on which betting chips can be placed, each such placement thereby constituting one of the set of standard available bets.

These games are not only popular in such traditional live physical form but also in modern adaptations embodying simulated, virtual and automated technologies to provide for simulated, virtual and automated casino table games in various electronic-terminal based and on-line forms.

It may be seen as desirable for those simulated, virtual and automated games to follow the appearance and the game play procedures of the physical form table game as closely as practicable. In particular, it is common for such games to provide a simulated, virtual or automated game outcome apparatus that has the look and feel of, and provides wagering options identical to, that of the traditional live physical game being simulated. Thus for example, a simulated or virtual roulette game will present a simulated or virtual roulette table with a presentation of a wheel to determine game outcome and a presentation of a wagering area on which simulated or virtual betting chips can be placed. However, the advent of simulated, virtual and automated games also creates a possibility for non-standard variants that would not be practicable for conventional physical apparatus. For example in the case of roulette, non-standard variants that include more numbers, such as 100/1 Roulette and 88/1 roulette, where the number layouts are increased to offer higher odds and where other presentations of the number selection than a simulated wheel may be employed. Such non-standard variants may be simpler to present on electronic display and such games tend not to occur in physical reality as tables.

Established table games operate to an established set of wagering options each with established fixed odds that are determined with reference to the probability of an associated outcome being produced by the game outcome apparatus. A successful wager is settled by setting a wagered amount or stake against the appropriate fixed-odds multiplier to produce a returned amount or payout. The stake may be limited by the provider of the content who sets minimum and maximum to be placed upon the layout, by game or regulatory rules or legislation. In particular, regulatory rules or legislation may set a maximum for the stake allowed in relation to simulated, virtual and automated games. Since a typical established game provides a finite number of wagering options with an associated finite set fixed odds, such a maximum stake also defines a finite set of returned amounts or payouts for successful bets, and defines a maximum returned amount or payout for the standard set of wagering options provided by the game.

Players of table games may typically place a range of wagers across multiple outcomes from a single gaming event, in order to control the volatility of their risk, and also to cover ‘favourite’ bets. For example, in the case of roulette, players may typically place a range of wagers on a single spin covering multiple numbers and patterns. A maximum stake rule can impact on a player's flexibility in this regard. In certain jurisdictions, the maximum legal stakes permitted have rendered roulette games unviable as stakes are too low to enable players to play the game as they would wish with multiple chip placement.

It is generally desirable to enhance the wagering options offered to players without detracting from the traditional game.

It may be desirable for a player to be able to place a wager determined by a desired payout for a given stake rather than by a desired stake. It may be desirable for a player to be able to place a wager determined by a desired payout that exceeds a maximum payout that would be produced by the established fixed odds for an outcome when mediated by a mandated maximum stake. It may be desirable for a player to be able to place a series of wagers on a single game outcome based on a range of wagering options.

However, this is made difficult by the long-standing and accepted game rules and odds established for traditional casino table games, in particular where a relatively low maximum stake is also set.

The invention seeks to address some or all of the above disadvantages.

The invention in particular seeks to offer additional wagering options in relation to established traditional table games in a way that maintains and embodies the underlying game play procedures, set of wagering options and associated fixed odds of traditional casino table games.

The invention in particular seeks to offer wagering options in relation to established traditional table games that allow a player to determine a more varied betting pattern based on a desired return for a given stake, and for example a maximum stake, in a way that maintains and embodies the underlying game play procedures, set of wagering options and associated fixed odds of traditional casino table games.

The invention in particular seeks to offer enhancements applicable to simulated, virtual and automated games based on and embodying the underlying game play procedures, set of wagering options and associated fixed odds of the traditional casino table games.

### SUMMARY OF THE INVENTION

In accordance with the invention in a first aspect, a gaming system comprises:

a playing surface having:
a game wager placement area having markings thereon for identification and placement of wagers entered by a player, the game wager placement area defining a plurality of locations, each such location indicating one of a set of standard available wagers associated with an outcome of the game outcome generator;
a game outcome area including a game outcome generator configured to
determine and show one of a plurality of chance game outcomes;

a plurality of tokens each having a nominal value, each such token being placeable onto a selected location on the game wager placement area, thereby to constitute placement one of the set of standard available wagers;

whereby wagers may be placed according to a set of predefined wagering rules associated with the said plurality of locations;

a feature entry outcome generator configured to determine, for each game event having a pre-determined wagered amount, a choice between at least a first outcome with a feature entry probability and a second outcome, wherein:
in the event of the first outcome the game outcome generator is caused to determine and show one of the plurality of chance game outcomes and wagers placed by a player are settled based on the nominal value of each placed token
in accordance with the set of predefined wagering rules;
in the event of the second outcome the pre-determined wagered amount is lost;
the feature entry probability is determined by a calculation that takes account of the ratio of the pre-determined wagered amount to the total nominal value of each placed token.

Most simply, the feature entry outcome generator is configured to determine a binary choice between only the two above outcomes, and the feature entry probability is determined as the ratio of the pre-determined wagered amount to the total nominal value of each placed token. However, the invention encompasses variants where additional outcome options are provided from the feature entry outcome generator. For example, a third option may return the pre-determined wagered amount.

The game thus has two parts, a game feature based on the game outcome generator and an entry feature based on the feature entry outcome generator. The feature entry outcome generator determines whether the game outcome generator is in play as a bonus feature during the game event. It does so in accordance with a feature entry probability that is scaled by a calculation that takes account of the ratio of the pre-determined wagered amount to the total nominal value of each placed token in such a way that the overall success probability for the game event is maintained constant, the pre-determined wagered amount for the game event is applied, but in the event of the first outcome bets are still settled by the usual rules and at the usual odds.

The gaming system is thus a system for playing a game that includes wagering on the outcome. The game is for example a traditional casino table game such as baccarat, blackjack, craps, roulette or the like. These games are characterised by having a defined and finite set of wagering options thereby constituting a set of standard available bets with established fixed odds. The playing surface in this case comprises a table game playing surface that includes a traditional wagering layout defining a plurality of locations on which a token can be placed, each such placement thereby constituting one of the set of standard available bets and that also includes a table game outcome generator to determine a chance game outcome, such as dice, playing cards, a roulette wheel etc. The token thus serves as a betting chip that may be placed to represent such a bet in a generally conventional manner.

In a particular preferred case the game is roulette and the playing surface comprises a roulette table playing surface that includes a roulette wagering layout defining a plurality of locations on which a standard available bet may be placed and further includes a roulette wheel or other means of presenting a number.

More completely in such a case, the invention comprises a roulette game comprising:

a playing surface having:
a roulette wheel or other means of presenting a number;
a roulette wagering layout area having markings thereon for identification and placement of wagers entered by a player, a defining a plurality of locations, each such location indicating one of a set of standard available wagers associated with an outcome of the roulette wheel or other means of presenting a number;

a plurality of tokens each having a predetermined nominal value, each such token being placeable onto a selected location on the roulette wagering layout area, thereby to constitute placement one of the set of standard available wagers;

whereby wagers may be placed according to a set of predefined wagering rules associated with the said plurality of locations;

a roulette feature entry outcome generator configured to determine a choice between at least a first outcome with a roulette feature entry probability and a second outcome, wherein:
in the event of the first outcome the roulette wheel or other means of presenting a number is caused to determine and show a number and wagers placed by a player are settled based on the nominal value of each placed token in accordance with the set of predefined wagering rules;
in the event of the second outcome the pre-determined wagered amount is lost;
the roulette feature entry probability is determined by a calculation that takes account of the ratio of the pre-determined wagered amount to the total nominal value of each placed token.

Again, the roulette feature entry outcome generator determines whether the roulette feature is in play. Conveniently, the roulette feature entry outcome generator is configured to determine a binary choice between only the two listed outcomes, and the feature entry probability is determined as the ratio of the pre-determined wagered amount to the total nominal value of each placed token.

When used hereinabove references to a playing surface such as a table game playing surface include a physical surface such as the surface of a physical table at a casino or like location having wagering layout markings thereon for identification and placement of wagers and including a physical game outcome apparatus, but additionally include a simulated or virtual playing surface for example presented on a suitable display.

Optionally, the simulated or virtual playing surface is configured to provide a playing area that has the look and feel of, and provides wagering options identical to, that of the traditional live physical game being simulated. Thus for example, a simulated or virtual roulette game will present a simulated or virtual roulette table with a presentation of a wheel to determine game outcome and a presentation of a wagering area on which simulated or virtual tokens can be placed as betting chips. Alternatively, the simulated or virtual playing surface may be configured to present a non-standard variant of a traditional live physical game that is inspired by but does not exactly simulate the traditional live physical game. For example in the case of roulette, non-standard variants that include more numbers, such as 100/1 roulette and 88/1 roulette, where the number layouts are increased to offer higher odds and where other presentations of the number selection than a simulated wheel may be employed.

Such a simulated or virtual playing surface may be embodied for example in an electronic-terminal based system or an on-line system.

During use in a game play event, a player makes wagers on prospective outcomes of the game outcome generator in the usual manner by placement of each of one or more tokens having a nominal value onto a location in the game wager placement area, each such location representing a particular established bet in accordance with the wagering rules of the game being played. The process to that extent identical to, and provides wagering options identical to, that of a conventional embodiment of the game. In particular, the wagered amount of any bet placed may be considered to be the nominal value of the token, and the prospective resultant payout may be settled by setting the wagered amount against the appropriate fixed-odds multiplier.

A player is free to wager any amounts, in any pattern, and to place a series of wagers on a single game outcome based on a range of wagering options.

However, the invention is characterised by the additional provision of a feature entry outcome generator which in effect determines whether the wagers on the game outcome generator are in play at all. Each game play has two effective stages, a first “feature entry” stage which is a simple binary outcome, and a second “bonus” or “game feature” stage which is activated and put in play if the player is successful in the first stage, and which constitutes the main game, and for example the table game such as roulette, on which the wagers have been placed. The player freely chooses the total nominal value of any tokens placed on the wagering layout of the main game bonus feature, and therefore chooses the total nominal value of any bets placed, but the probability of gaining entry into this bonus feature at all is determined by a calculation that takes account of the ratio of the predetermined total wagered amount to the total nominal value of the tokens in place on the layout.

It is this feature that allows players to place wagers of any amounts and in any patterns they desire, to have those wagers settled according to the usual rules and fixed odds for the game in play, but at the same time to fix a predetermined wagered amount (that is, a predetermined actual stake which may for example be a preset maximum stake or a stake chosen by a player) for the game play event.

The player may be presented with a standard game wager placement area layout with the user able to place chips of particular value on various potential outcomes, each with their own pre-determined pay-outs. The player may place a range of bets across multiple outcomes from a single event in the usual way. The invention provides for a method for players to place chips on the layout before the game commences whilst selecting a fixed stake for the entire game cycle.

It allows the player flexibility of chip placement within a fixed stake framework. It provides for a simple bonus event entry mechanic to be clear to the player. It is this bonus event entry mechanic that ties to total fixed stake for the entire game cycle to the specific bets based on placed chips. The nominal value of those bets, and the odds against which they are settled when the bonus game feature is entered, are not changed.

Many game providers and designers have attempted to implement modifications to games such as roulette games over the last 15 years where a fixed stake mechanic is used to allow entry to a roulette feature.

All of these however, have used what is defined as a ‘pre game’ gamble where the player is in reality simply trying to multiply their initial stake in order to then use this as chips on a roulette table. This is a fundamentally different approach to the above design since the player has no control over the probability of accessing the feature, nor may they place the chips on the layout in advance, thereby effectively ‘designing’ the award schedule themselves.

By contrast, the present invention creates at a first entry stage a bonus feature entry mechanic where in the event that the player has a positive outcome at the entry stage, the primary game is played as a second, bonus feature stage with all bets having their nominal values as placed, and all settled according to the standard rules and odds, and instead adjusts the bonus feature entry frequency based on a ratio of the nominal amounts of the placed bets to the maximum stake.

This invention enables the player to set their own bonus entry frequency, and at the same time to design their own awards schedule for the bonus feature stage, thereby controlling the volatility of the game while retaining a fixed stake for the overall game.

Advantageously, this makes the game adaptable for any scenario where it is desired to set a fixed stake and for example a maximum stake but still allow the player to continue to design their preferred award schedule for the bonus part of the game. This may be particularly suited to games such as roulette where routine game play involves the placement of multiple bets across multiple outcomes from a single event. However, the principles of the invention may be applied to any game where such a feature would be advantageous, and in particular to various traditional casino table games.

The principles of the invention may be applied to physical games wherein the playing surface is a physical surface, and in particular to physical table games wherein the playing surface is the surface of a physical table at a casino or like location. However, in a particular preferred embodiment, a gaming system in accordance with the first aspect of the invention is a virtual gaming system at least comprising a virtual game playing surface generation module for generating a virtual playing surface having a game wager placement area and a game outcome area as above described. Further additional features of the playing surface as above described may additionally be generated by the playing surface generation module.

The virtual game playing surface generation module is adapted to generate a virtual playing surface suitable for display on a suitable visual display. Optionally, the gaming system of the invention may additionally comprise a visual display screen. For example, the gaming system is embodied in a game terminal unit incorporating a visual display screen. Additionally or alternatively, the playing surface generation module may be adapted to communicate such a virtual playing surface for display on a remote visual display, for example via a distributed network.

Optionally, a virtual gaming system according to this aspect of the invention may further comprise one or more of:
a virtual game outcome generation module configured to determine one of a plurality of chance game outcomes;
a virtual game wager placement module configured to permit a user to place wagers in the form of virtual tokens each having a predetermined nominal value on the virtual game wager placement area, thereby to constitute placement of one of the set of standard available wagers;
a virtual game wager settlement module to settle each wager according to a set of predefined wagering rules based on the outcome generated by the game outcome generator;
a virtual feature entry outcome generator module configured to determine the choice between at least the first and the second feature entry outcomes as above described;
a virtual game wagered amount setting module enabling user to set a pre-determined fixed wagered amount for each game event.

In the case where the gaming system in accordance with the first aspect of the invention is a virtual gaming system comprising one or more virtual game modules as above described, each such module may optionally be provided as a suitably programmed general purpose or special purpose computer. Each such module may optionally be provided embodied in a discrete game terminal unit to be played directly by the player. Additionally or alternatively, some or all of the modules may be provided remotely of the player via a distributed network.

Preferably, the playing surface is configured to include a feature entry outcome area which incorporates a display of the feature entry outcome. In a possible embodiment, this may include a display area in which the possible outcomes are respectively identified as fractions of the total area which fractions are in proportion to the respective probabilities of the outcomes as determined in accordance with the foregoing. The areas may for example be different colours. In the preferred case, there are two such areas corresponding to the two outcomes whereby either the bonus feature is in play or it is not.

In a particular preferred embodiment, the gaming system is a system for playing roulette. Traditionally in such a case, the game outcome apparatus comprises a wheel divided into segments each of which has a coloured and numbered pocket for receiving a ball. Conventionally, the wheel may include 36 segments numbered 1 to 36, divided between two distinct colours, such as red and black, with one or two additional segments numbered 0 and optionally 00.

The wheel is configured to determine a game outcome by causing the wheel to spin, and causing the ball to come to rest in one of the respectively numbered pockets. Where the gaming system is a virtual gaming system, the game outcome apparatus is adapted to present an outcome comprising a number, and preferably adapted to do so by presenting a virtual display of a spinning wheel, and of a ball coming to rest in one of the said pockets.

However, the principles of the invention may equally apply to non-standard variants of roulette, for example those that include more numbers to offer higher odds and/or where other presentations of the number than a simulated wheel may be employed.

In accordance with the invention in a second aspect, a method for the placement and settlement of wagers on a game outcome comprises:

providing a game outcome generator to determine and show one of a plurality of chance game outcomes;

predetermining a set of wagering rules and fixed odds for each of a plurality of standard available wagers associated with an outcome of the game outcome generator;

during a game event:

facilitating the placement by a player of a plurality of wagers from the set of standard available wagers each with a nominal value determined by the player;

setting a predetermined wagered amount;

calculating a feature entry probability that takes account of the ratio of the pre-determined wagered amount to the total nominal value of each placed token;

determining a feature entry outcome as a choice between at least a first outcome with the feature entry probability and a second outcome;

in the event of the first outcome causing the game outcome generator to determine and show one of the plurality of chance game outcomes and settling wagers placed on the nominal value of each placed token in accordance with the set of predefined wagering rules;

in the event of the second outcome treating the pre-determined wagered amount as lost.

In particular preferably the method comprises calculating a feature entry probability as the ratio of the pre-determined wagered amount to the total nominal value of each placed wager;

determining a feature entry outcome as a binary choice between a first outcome with the feature entry probability and a second outcome;

in the event of the first outcome causing the game outcome generator to determine and show one of the plurality of chance game outcomes and settling wagers placed on the nominal value of each placed token in accordance with the set of predefined wagering rules;

in the event of the second outcome treating the pre-determined wagered amount as lost.

However, the invention encompasses variants where additional outcome options are provided at the feature entry stage and are accounted for in calculating the feature entry probability.

In a possible embodiment the step of facilitating the placement by a player of a plurality of wagers from the set of standard available wagers each with a nominal value determined by the player comprises:

providing a game wager placement area having markings thereon for identification and placement of wagers entered by a player, the game wager placement area defining a plurality of locations, each such location indicating one of a set of standard available wagers associated with an outcome of the game outcome generator;

facilitating the placement by a player of a plurality of tokens each having a predetermined nominal value, each such token being placeable onto a selected location on the game wager placement area, thereby to constitute placement one of the set of standard available wagers.

Other preferred features of the method of the second aspect of the invention will be understood by analogy from the description of the system of the first aspect of the invention and its use.

In third aspect of the invention, an apparatus for the placement and settlement of wagers comprises an apparatus adapted to perform the foregoing method.

Conveniently such an apparatus may comprise a suitably programmed general purpose or special purpose computer.

Correspondingly in a fourth aspect of the invention a program for a computer comprises a set of instructions for example carried on a computer readable medium, executable when loaded onto a processor, and for example the processor of a general purpose or special purpose computer, to cause the processor to perform the method of the second aspect of the invention.

### BRIEF DESCRIPTION OF THE DRAWINGS

The invention will now be described by way of example only with reference to example screen presentations from a virtual roulette game embodying the principles of the invention, in which;

FIG. 1 represents the pre-game cycle as bets are placed;

FIG. 2 represents the commencement of the game, and the playing of the entry feature;

FIG. 3 represents the playing of the roulette feature as a bonus feature in the event of a successful outcome from the entry feature.

### DETAILED DESCRIPTION OF THE PREFERRED EMBODIMENT(S)

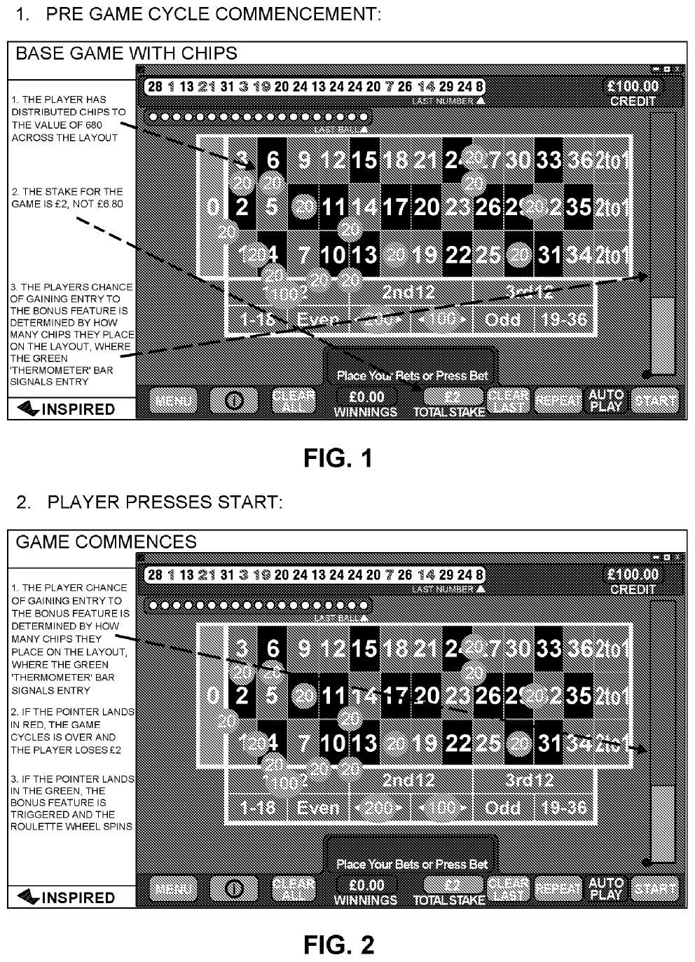

Each of FIGS. 1 to 3 represents the visual display of the wager placement area of a virtual roulette game during various stages of game play, together with certain other information. The betting layout is of an essentially standard design, carrying numbers 1 to 36 conventionally coloured either red or black, and allowing placement of bets, by the placement of virtual chips, on each number and the usual additional bets on groups of numbers, columns of numbers, red/black, high/low, odd/even.

FIG. 1 shows the pre-game cycle commencement as bets are placed.

The game is played with a pre-determined total stake for each game play event, which in the illustrated embodiment is set as £2 (or 200 points), and is displayed on the menu bar at the bottom of the screen.

However, the player is free to distribute chips across the betting layout to any value desired. In the illustrated embodiment the player has distributed chips to the value of 680 points across the layout in various combination bets.

The invention is distinctly characterised in the way in which this betting total of 680 is reconciled with the maximum stake of £2 (200 points). In contrast to prior art systems, which have employed an odds multiplier principle, the odds on the main game are left unchanged and the bets are left to stand with their nominal chip values. Instead, the invention provides for that game to constitute a bonus feature, with the player's chance of gaining entry to the bonus feature being determined by how many chips are placed on the layout. In this case, the player's chance of gaining entry constitutes a probability of 200/680.

A visual representation of this probability of gaining entry is presented in the thermometer bar at the right hand side of the screen. The thermometer bar comprises a green coloured portion and a red coloured portion. The respective lengths of these two portions are in direct proportion to the respective probabilities of success and failure (respectively green and red) at the entry feature stage.

Once the player is satisfied with the placement of bets, the game commences. A virtual start button may be provided for activation by the player.

FIG. 2 shows a first phase of game play in which the entry feature is active. The entry feature is displayed by a moving virtual pointer which moves up and down the thermometer bar on the right of the displayed screen, and whose final position is representative of the entry outcome. If the pointer is displayed as landing in the green part of the thermometer, the bonus feature is triggered and a virtual roulette wheel (not shown) spins. If the pointer lands in the red, all bets are deemed lost, and the £2 stake is lost.

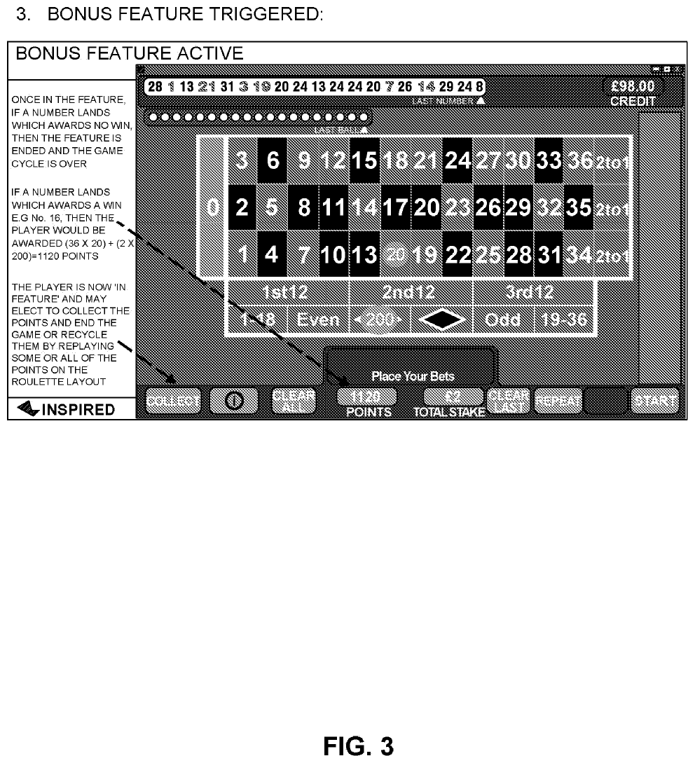

FIG. 3 represents the triggering of the bonus feature. At this point, the virtual roulette wheel (not shown) spins and a game outcome in the form of a roulette number is presented. At this point, all bets are settled based on the standard odds for each bet in respect of a chip placed in a winning position and to the full nominal amounts represented on the chips.

If a number is produced which results in a no win award, then the feature is ended and the game cycle is over.

If a number is produced on which a win is due, then the win is awarded based on the nominal value and the standard fixed odds. For example, in the example displayed in FIG. 3, it is represented that number 16 has resulted. The player has two winning bets. There is a bet of 20 on the number itself and a bet of 200 on red. The award to the player is (36×20)+(2×200)=1120 points.

The player is now “in feature” and may elect to collect the points as a return of £11.20, and end the game, or recycle them by replaying some or all of the points on the roulette layout.

Thus, the player is effectively enabled to set their own bonus entry frequency and to play the bonus game in an entirely standard way whilst still complying with the pre-set fixed stake, for example making the game particularly adaptable to jurisdictions operating relatively low fixed staking requirements.

1. A gaming system comprising:
a playing surface having:
a game wager placement area having markings thereon for identification and placement of wagers entered by a player, the game wager placement area defining a plurality of locations, each such location indicating one of a set of standard available wagers associated with an outcome of the game outcome generator;
a game outcome area including a game outcome generator configured to determine and show one of a plurality of chance game outcomes;
a plurality of tokens each having a nominal value, each such token being placeable onto a selected location on the game wager placement area, thereby to constitute placement one of the set of standard available wagers;
whereby wagers may be placed according to a set of predefined wagering rules associated with the said plurality of locations;
a feature entry outcome generator configured to determine, for each game event having a pre-determined wagered amount, a choice between at least a first outcome with a feature entry probability and a second outcome, wherein:
in the event of the first outcome the game outcome generator is caused to determine and show one of the plurality of chance game outcomes and wagers placed by a player are settled based on the nominal value of each placed token in accordance with the set of predefined wagering rules;
in the event of the second outcome the pre-determined wagered amount is lost;
the feature entry probability is determined by a calculation that takes account of the ratio of the pre-determined wagered amount to the total nominal value of each placed token.

2. A gaming system according to claim 1 wherein the feature entry outcome generator is configured to determine a binary choice between only the said two outcomes, and the feature entry probability is determined as the ratio of the pre-determined wagered amount to the total nominal value of each placed token.

3. A gaming system according to claim 1 wherein the feature entry outcome generator is configured to determine a choice between the said two outcomes, and at least one third outcome, the at least one third outcome for example being to return the pre-determined wagered amount.

4. A gaming system according to claim 1 comprising a system for a casino table game, wherein the playing surface comprises a table game playing surface that includes a traditional wagering layout defining a plurality of locations on which a token can be placed, each such placement thereby constituting one of the set of standard available bets.

5. A gaming system according to claim 4 further comprising a table game outcome generator to determine a chance game outcome.

6. A gaming system according to claim 4 wherein the game is roulette and the playing surface comprises a roulette table playing surface that includes a roulette wagering layout defining a plurality of locations on which a standard available bet may be placed and further includes a roulette wheel or other means of presenting a number.

7. A gaming system according to claim 1 wherein the playing surface is a physical surface, and for example is the surface of a physical table at a casino or like location.

8. A gaming system according to claim 1 comprising a virtual gaming system having a virtual game playing surface generation module for generating a virtual playing surface having a game wager placement area and a game outcome area.

9. A gaming system according to claim 8 further comprising one or more of:
a virtual game outcome generation module configured to determine one of a plurality of chance game outcomes;
a virtual game wager placement module configured to permit a user to place wagers in the form of virtual tokens each having a predetermined nominal value on the virtual game wager placement area, thereby to constitute placement of one of the set of standard available wagers;
a virtual game wager settlement module to settle each wager according to a set of predefined wagering rules based on the outcome generated by the game outcome generator;
a virtual feature entry outcome generator module configured to determine the choice between at least the first and the second feature entry outcomes;
a virtual game wagered amount setting module enabling user to set a pre-determined fixed wagered amount for each game event.

10. A roulette game comprising:
a playing surface having:
a roulette wheel or other means of presenting a number;
a roulette wagering layout area having markings thereon for identification and placement of wagers entered by a player, a defining a plurality of locations, each such location indicating one of a set of standard available wagers associated with an outcome of the roulette wheel or other means of presenting a number;
a plurality of tokens each having a predetermined nominal value, each such token being placeable onto a selected location on the roulette wagering layout area, thereby to constitute placement one of the set of standard available wagers;
whereby wagers may be placed according to a set of predefined wagering rules associated with the said plurality of locations;
a roulette feature entry outcome generator configured to determine a choice between at least a first outcome with a roulette feature entry probability and a second outcome, wherein:
in the event of the first outcome the roulette wheel or other means of presenting a number is caused to determine and show a number and wagers placed by a player are settled based on the nominal value of each placed token in accordance with the set of predefined wagering rules;
in the event of the second outcome the pre-determined wagered amount is lost;
the roulette feature entry probability is determined by a calculation that takes account of the ratio of the pre-determined wagered amount to the total nominal value of each placed token.

11. A method for the placement and settlement of wagers on a game outcome comprising:
providing a game outcome generator to determine and show one of a plurality of chance game outcomes;
predetermining a set of wagering rules and fixed odds for each of a plurality of standard available wagers associated with an outcome of the game outcome generator;
during a game event:
facilitating the placement by a player of a plurality of wagers from the set of standard available wagers each with a nominal value determined by the player;
setting a predetermined wagered amount;
calculating a feature entry probability that takes account of the ratio of the pre-determined wagered amount to the total nominal value of each placed token;
determining a feature entry outcome as a choice between at least a first outcome with the feature entry probability and a second outcome;
in the event of the first outcome causing the game outcome generator to determine and show one of the plurality of chance game outcomes and settling wagers placed on the nominal value of each placed token in accordance with the set of predefined wagering rules;
in the event of the second outcome treating the pre-determined wagered amount as lost.

12. A method according to claim 11 comprising:
calculating a feature entry probability as the ratio of the pre-determined wagered amount to the total nominal value of each placed wager;
determining a feature entry outcome as a binary choice between a first outcome with the feature entry probability and a second outcome;
in the event of the first outcome causing the game outcome generator to determine and show one of the plurality of chance game outcomes and settling wagers placed on the nominal value of each placed token in accordance with the set of predefined wagering rules;
in the event of the second outcome treating the pre-determined wagered amount as lost.

13. A method according to claim 11 wherein the facilitating the placement by a player of a plurality of wagers from the set of standard available wagers each with a nominal value determined by the player comprises:
providing a game wager placement area having markings thereon for identification and placement of wagers entered by a player, the game wager placement area defining a plurality of locations, each such location indicating one of a set of standard available wagers associated with an outcome of the game outcome generator;
facilitating the placement by a player of a plurality of tokens each having a predetermined nominal value, each such token being placeable onto a selected location on the game wager placement area, thereby to constitute placement one of the set of standard available wagers.

14. A program for a computer comprising a set of instructions carried on a computer readable medium, executable when loaded onto a processor, to cause the processor to perform the method of:
providing a game outcome generator to determine and show one of a plurality of chance game outcomes;
predetermining a set of wagering rules and fixed odds for each of a plurality of standard available wagers associated with an outcome of the game outcome generator;
during a game event:
facilitating the placement by a player of a plurality of wagers from the set of standard available wagers each with a nominal value determined by the player;
setting a predetermined wagered amount;
calculating a feature entry probability that takes account of the ratio of the pre-determined wagered amount to the total nominal value of each placed token;
determining a feature entry outcome as a choice between at least a first outcome with the feature entry probability and a second outcome;
in the event of the first outcome causing the game outcome generator to determine and show one of the plurality of chance game outcomes and settling wagers placed on the nominal value of each placed token in accordance with the set of predefined wagering rules;
in the event of the second outcome treating the pre-determined wagered amount as lost.
